(19) United States
(12) Patent Application Publication
(10) Pub. No.: US 2025/0227468 A1
(43) Pub. Date: Jul. 10, 2025

(54) TRACTOR-TO-TRAILER VERIFICATION SYSTEM

(71) Applicant: AMETEK, INC., Berwyn, PA (US)

(72) Inventors: Uday SHANKAR, Herndon, VA (US); Siamak AZMOUDEH, Tampa, FL (US)

(73) Assignee: AMETEK, INC., Berwyn, PA (US)

(21) Appl. No.: 18/844,444

(22) PCT Filed: Mar. 2, 2023
(86) PCT No.: PCT/US2023/014342

§ 371 Date: Sep. 6, 2024

Related U.S. Application Data
(60) Provisional application No. 63/318,145, filed on Mar. 9, 2022.

(51) Int. Cl. H04W 12/06; H04W 4/02; H04W 4/40; H04W 12/63

(52) U.S. Cl. CPC H04W 12/06; H04W 4/025; H04W 4/40; H04W 12/63

(57) ABSTRACT

Various verification systems are disclosed. A tractor-to-trailer verification system includes a tractor driver smart device and a trailer device in the trailer. The trailer device includes a trailer transceiver and a trailer controller. The tractor-to-trailer verification system is configured to execute, on the tractor driver smart device, a driver-side software application displaying trailer verification instructions to the tractor driver, the trailer verification instructions received by the driver-side software application from a customer device, the trailer verification instructions including a trailer ID of the trailer and a tractor owner ID of the tractor, transmit, from the trailer transceiver to the tractor driver smart device, the trailer ID of the trailer, and confirm, via the driver-side software application, a match between the trailer ID and the tractor owner ID

### CROSS-REFERENCE TO RELATED APPLICATIONS

This Application is related to, and claims the benefit of priority of U.S. Provisional Application No. 63/318,145, entitled TRACTOR-TO-TRAILER VERIFICATION SYSTEM, filed on 9 Mar. 2022, the contents of which are incorporated herein by reference in their entirety for all purposes.

### FIELD

This disclosure relates generally to a tractor-to-trailer verification system.

### BACKGROUND

In today's market, large transportation companies are becoming more heavily reliant on hiring smaller 3^{rd} party haulers to transport their trailers throughout the various phases of the product supply chain. For example, a transportation company that owns a fleet of trailers may employ multiple 3^{rd} party haulers. These 3^{rd} party haulers each have multiple tractor drivers that are typically responsible for picking up the trailers from a shipping yard and hauling the trailers to respective destinations. Picking up a trailer generally entails that the 3^{rd} party truck driver of the 3^{rd} party hauler locate and hook a tractor to an identified trailer that is assigned to the 3^{rd} party hauler by the customer. However, pickup errors occur when the 3^{rd} party truck drivers pick up the wrong trailer (e.g. picks up a trailer that was not assigned to the 3^{rd} party hauler). These types of pickup errors are happening with more frequency due to reliance on multiple 3^{rd} party haulers that may or may not be sophisticated. The customer may not have a means to quickly and easily detect/correct these pickup errors, which results great loss of productivity and customer service issues.

### SUMMARY

Various verification systems are disclosed.

In one example, a tractor-to-trailer verification system includes a tractor driver smart device and a trailer device in the trailer. The trailer device includes a trailer transceiver and a trailer controller. The tractor-to-trailer verification system is configured to execute, on the tractor driver smart device, a driver-side software application displaying trailer verification instructions to the tractor driver, the trailer verification instructions received by the driver-side software application from a customer device, the trailer verification instructions including a trailer ID of the trailer and a tractor owner ID of the tractor, transmit, from the trailer transceiver to the tractor driver smart device, the trailer ID of the trailer, and confirm, via the driver-side software application, a match between the trailer ID and the tractor owner ID.

In another example, a hauler-to-asset verification system includes a hauler smart device and an asset device attached to an asset. The asset device includes an asset transceiver and an asset controller. The hauler-to-asset verification system is configured to execute, on the hauler smart device, a software application displaying asset verification instructions to the hauler, the asset verification instructions received by the software application from a customer device, the asset verification instructions including an asset ID of the asset and a hauler smart device ID of the hauler smart device, transmit, from the asset transceiver to the hauler smart device, the asset ID of the asset, and confirm, via the software application, a match between the asset ID and the hauler smart device ID.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 shows a side view of a trailer loaded with freight and including an on-trailer solution and a driver smart device in the cab, according to an aspect of the disclosure.

FIG. 2 shows a block diagram of the tractor-to-trailer verification system, according to an aspect of the disclosure.

FIG. 3 shows a flowchart of the operation of the tractor-to-trailer verification system, according to an aspect of the disclosure.

FIG. 4 shows another flowchart of the operation of the tractor-to-trailer verification system, according to an aspect of the disclosure.

FIG. 5 shows yet another flowchart of the operation of the tractor-to-trailer verification system, according to an aspect of the disclosure.

FIG. 6 shows an example of the driver-side software application for the tractor-to-trailer verification system, according to an aspect of the disclosure.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

The following detailed description provides a practical and reliable solution to prevent problems resulting from drivers hauling the wrong trailer. The definition of the wrong trailer being a physical trailer that is different from the trailer the driver was either assigned by the customer (e.g. transportation company).

An objective of an effective solution is to provide a reliable and timely check that alerts drivers and/or customers when hauling a wrong trailer either before drivers have left a facility or within a very short time window after leaving the facility. The ideal solution is a virtual solution that does not require additional hardware other than the hardware already deployed on the trailer and the driver's smart device, and assumes the burden of tractor-to-trailer verification.

This solution is referred to herein as a “tractor-to-trailer verification system”. In general, the tractor-to-trailer verification system determines the specific trailer that is physically hooked to the tractor, works reliably in noisy communication and high traffic locations, is reliable and scalable, is available on common platforms (e.g. Android and IOS), and provides a means to eliminate the dependency on the driver to perform tractor-to-trailer verification.

Generally, the tractor-to-trailer verification system includes a customer-side software application executed by the customer device (e.g. trailer owner PC) and a driver-side software application executed by the 3^{rd} party tractor driver smart device (e.g. smartphone). The tractor-to-trailer verification provides the tractor driver with trailer verification instructions based on instructions received from the customer (e.g. trailer owner) via the customer-side software application. The driver-side software application, via the tractor driver smart device, performs communication with the on-trailer solution and the tractor-to-trailer verification system to ensure accurate matching between the 3^{rd} party hauler and the customer trailer based on the customer instructions. Appropriate action is taken if there is mismatch (e.g. generate alerts and notifications as required).

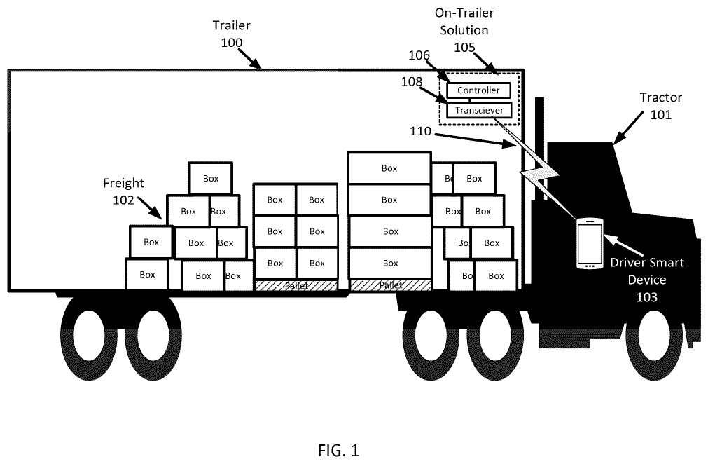

FIG. 1 shows an example of container 100 (e.g., trailer) loaded with freight 102 (e.g., boxes, pallets, etc.). Trailer 100 includes an on-trailer solution 105 having a controller (e.g. CPU, etc.) 106 and a wireless transceiver 108 (e.g. Bluetooth, WiFi, Cellular, GPS, etc.). Although not shown, in one example, on-trailer solution 105 may be powered by a power source of the trailer (e.g., connected to the container electrical wiring). In another example, the on-trailer solution 105 may be self-powered (e.g. battery powered, solar powered, etc.).

Tractor 101 includes a tractor driver smart device 103 (e.g. smartphone, tablet, etc.) having a CPU, a wireless transceiver (e.g. Bluetooth, WiFi, Cellular, etc.) and display/input device (e.g. Touch Screen, etc.) for outputting information to the tractor driver and receiving information from the tractor driver. The CPU and wireless transceiver of tractor driver smart device 103 are not shown for clarity. Tractor driver smart device 103 executes a driver-side software application that communicates to a tractor-to-trailer verification server to facilitate the tractor-to-trailer verification method.

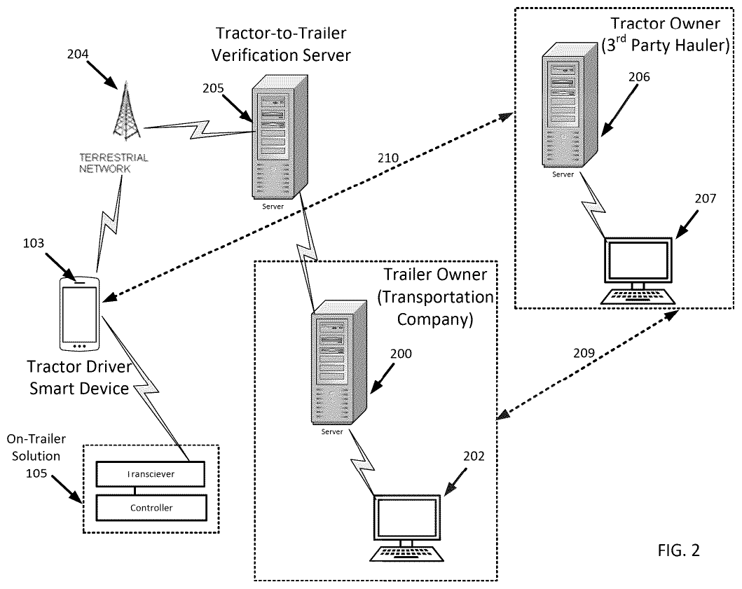

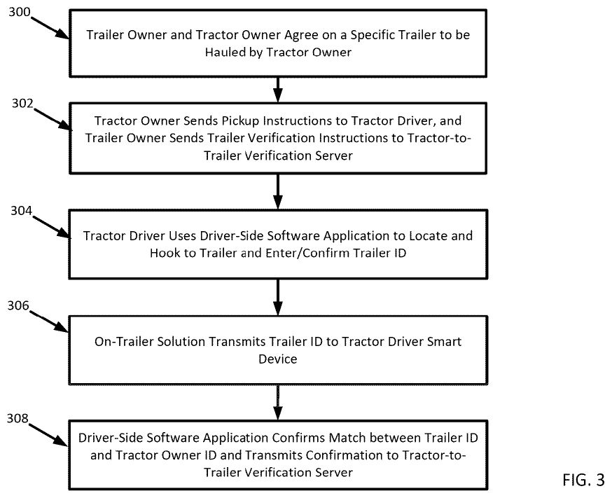

FIG. 2 shows a block diagram of the overall tractor-to-trailer verification system that includes tractor driver smart device 103, on-trailer solution 105, tractor-to-trailer verification server 205, trailer owner server 200 and trailer owner personal computer (PC) 202 communicating with each other either directly, or via a terrestrial network 204. FIG. 2 also includes tractor owner server 206, and tractor owner PC 207. It is noted that the trailer owner (e.g. customer) could be a transportation company owning a large fleet of trailers, and the tractor owner could be a 3^{rd} party hauler hired by the transportation company to haul their trailers. Although only one 3^{rd} party hauler is shown in FIG. 2, it is noted that the transportation company could contract with and communicate with multiple 3^{rd} party haulers (not shown). It is also noted that a logistics service provider (not shown) may act as middle-man between the tractor owner and trailer owner to facilitate proper tractor/trailer assignments (e.g. assigning trailers to one or more 3^{rd} party haulers). The operational examples of the system in FIG. 2 will now be described with respect to FIGS. 3-6.

In a first operational example shown in FIG. 3, the tractor owner (e.g. 3^{rd} party hauler) and the trailer owner (e.g. transportation company) use communication link 209 to agree upon a specific trailer for the tractor owner to haul (STEP 300). Communication link 209 may be an internet connection between tractor owner server 206 and tractor owner PC 207 with trailer owner server 200 and trailer owner PC 202, or may be a phone link between the companies. In either case, once an agreement is reached in step 300, the tractor owner sends pickup instructions to the tractor driver via communication link 210. Communication link 210 may be an internet connection between tractor owner server 206 and tractor owner PC 207 with tractor driver smart device 103, or may be a phone link between these devices. The pickup instructions (e.g. driver marching orders) may include various pieces of information including but not limited to trailer ID, pickup location, destination location and the like. It is noted that step 300 is performed between the tractor owner and the trailer owner independent of the tractor-to-trailer verification system.

In addition, one the agreement is reached between the trailer owner and the tractor owner, the trailer owner (e.g. customer) sends trailer verification instructions to tractor-to-trailer verification server 205 (STEP 302). The trailer verification instructions may include various pieces of information including but not limited to trailer ID and tractor owner ID (e.g. identification unique to the 3^{rd} party hauler that owns the tractor). The tractor driver uses the driver-side software application to locate and hook to the identified trailer and optionally enters the trailer ID or presses a hookup confirmation button in the driver-side software application (STEP 304). On-trailer solution 105 transmits the trailer ID to tractor driver smart device 103 (STEP 306). This transmission may be triggered by the tractor driver smart device 103 upon the driver-side software application detecting hookup of the trailer to the tractor, by detecting motion of the trailer (e.g., for a predetermined period of time or at a predetermined speed), by automated signal from a remote location (e.g. server 205) upon receipt of verification from the driver, or based on another predetermined event. Such transmission should begin within a predetermined period of time from the triggering event, e.g., within five minutes, or preferably within one minute, or more preferably within 30 seconds, or more preferably within 15 seconds, or more preferably within 10 seconds, in order to identify mismatches as promptly as possible.

Upon receiving the transmitted trailer ID from the in-trailer solution, tractor driver smart device 103 confirms the trailer ID via the driver-side software application which compares the received trailer ID to the trailer owner ID in the trailer verification instructions (STEP 308). This comparison and matching procedure may be repeated as the tractor-trailer leaves the pickup location to ensure that the received trailer ID is actually being transmitted from the trailer that is hooked to the tractor, and not from a nearby trailer in the shipping yard. If a match is determined (match between trailer ID and tractor owner ID in the trailer verification instructions), then a match confirmation may be displayed to the driver and also sent to the customer (e.g. transportation company). If a mismatch is determined, then a mismatch alert may be displayed to the driver and sent to the customer (e.g. transportation company).

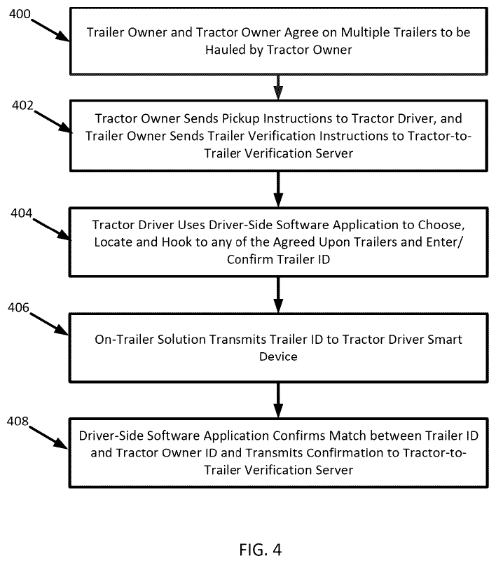

In a second operational example, the tractor driver may choose any one of a number of trailers to haul. For example, as shown in FIG. 4, the tractor owner (e.g. 3^{rd} party hauler) and the trailer owner (e.g. transportation company) use communication link 209 to agree on multiple trailers for tractor owner to haul (STEP 400). Once an agreement is reached in step 400, the tractor owner sends pickup instructions to the tractor driver via data link 210, and the trailer owner sends trailer verification instructions to the tractor-to-trailer verification server (STEP 402). The pickup instructions in this example may include various pieces of information including but not limited to various trailer IDs, various pickup locations, various destination locations and the like. The trailer verification instructions in this example may include various pieces of information including but not limited to various trailer IDs and the tractor owner ID. The driver uses the driver-side software application to locate and hook to one of the trailers and optionally enters the trailer ID or presses a hookup confirmation button in the driver-side software application (STEP 404). On-trailer solution 105 transmits the trailer ID to tractor driver smart device 103 (STEP 406). This transmission may be triggered by the tractor driver smart device 103 upon the driver-side software application detecting hookup of the trailer to the tractor, by detecting motion of the trailer (e.g., for a predetermined period of time or at a predetermined speed), by automated signal from a remote location (e.g. server 205) upon receipt of verification from the driver, or based on another predetermined event. Upon receiving the transmitted trailer ID from the in-trailer solution, tractor driver smart device 103 confirms the trailer ID via the driver-side software application which compares the received trailer ID to the trailer owner ID in the trailer verification instructions (STEP 408). Again, this comparison and matching procedure may be repeated as the tractor-trailer leaves the pickup location to ensure that the received trailer ID is actually being transmitted from the trailer that is hooked to the tractor, and not from a nearby trailer in the shipping yard. If a match is determined (match between trailer ID and tractor owner ID in the trailer verification instructions), then a match confirmation may be displayed to the driver and also sent to the customer (e.g. transportation company). If a mismatch is determined, then a mismatch alert may be displayed to the driver and sent to the customer (e.g. transportation company).

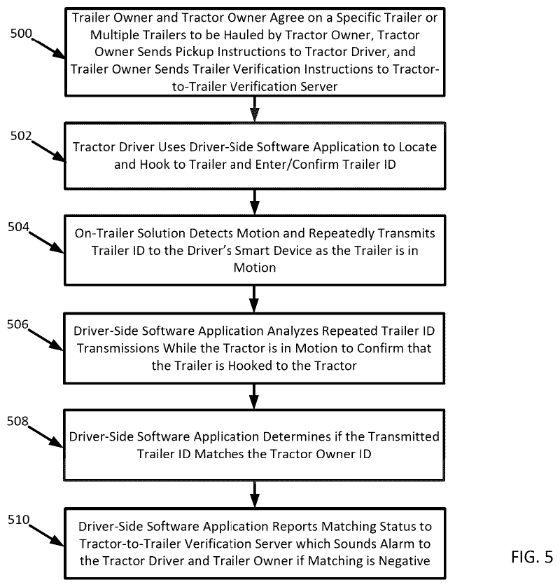

An overall operational example is shown in FIG. 5. First, the tractor owner (e.g. 3^{rd} party hauler) and the trailer owner (e.g. transportation company) use communication link 209 to agree on a specific trailer or multiple trailers for the tractor owner to haul (STEP 500). Once an agreement is reached, the tractor owner sends pickup instructions to the tractor driver via data link 210, and the trailer owner sends trailer verification instructions to the tractor-to-trailer verification server (STEP 500). The pickup instructions (e.g. driver marching orders) may include various pieces of information including but not limited to a specific trailer ID or various trailer IDs, a specific pickup location or various pickup locations, a specific destination location or various destination locations and the like. The trailer verification instructions may include various pieces of information including but not limited to a specific trailer ID or various trailer IDs and the tractor owner ID. The driver uses the driver-side software application to locate and hook to one of the trailers and optionally enters the trailer ID or presses a hookup confirmation button in the driver-side software application (STEP 502). On-trailer solution 105 transmits the trailer ID to tractor driver smart device 103 (STEP 504). This transmission may be triggered by the tractor driver smart device 103 upon the driver-side software application detecting hookup and/or motion of the trailer. Upon receiving the transmitted trailer ID from the in-trailer solution, tractor driver smart device 103 confirms the trailer ID via the driver-side software application which repeatedly compares the received trailer ID to the trailer owner ID in the trailer verification instructions as the trailer is in motion (STEP 506). If a match is determined (match between trailer ID and tractor owner ID in the trailer verification instructions) (STEP 508), then a match confirmation may be displayed to the driver and also sent to the customer (e.g. transportation company) (STEP 510). If a mismatch is determined, then a mismatch alert may be displayed to the driver and sent to the customer (e.g. transportation company) (STEP 510).

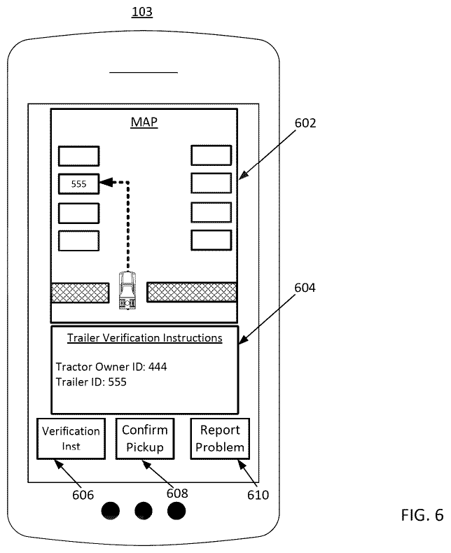

FIG. 6 shows an example of a graphical user interface (GUI) for the driver-side software application of the tractor-to-trailer verification system. The GUI may include optional map window 602 showing relative locations between the trailers and the tractor, verification instruction window 604 for showing the tractor owner ID and trailer ID's and optional interface buttons 606, 608 and 610 to request the trailer verification instructions, confirm the pickup has occurred and to report a problem with the pickup.

In one example, tractor-to-trailer verification server 205 may transmit the trailer ID and matching tractor owner ID to driver smart device 103. This transmission may be a push from tractor-to-trailer verification server 205 based on customer instructions, or may be a reply to a request for trailer verification instructions from driver smart device 103. In either case, the trailer ID and matching tractor owner ID are displayed in the driver-side software application. Optionally, map 602 may also be displayed in the driver-side software application to help aid the driver of tractor 101 in locating the identified trailer 555 in the shipping yard. The location of the identified trailer 555 may be marked based on a GPS location determined by on-trailer solution 105 when the trailer 555 was previously dropped off at the shipping yard. The GPS location of tractor 101 can be compared with the GPS location of trailer 555 and displayed on map 602.

Rather than GPS, the tractor-to-trailer verification system may also use measurable signal parameters from the transmission of the trailer ID from on-trailer solution 105 in order to aid the driver in locating the matching trailer in the pickup location (e.g. shipping yard) and to more accurately confirm that the proper trailer has been hooked up. These measurable signal parameters include but are not limited to received signal strength (RSSI) and round-trip-timing (RTT) of a ping sent between the driver smart device and the on-trailer solution. For example, as the driver navigates the tractor through the pickup location (e.g. shipping yard), the driver smart device may send a request to nearby on-trailer solutions to send their ID. When a matching ID is detected, the driver smart device may use RSSI and/or RTT to locate the matching trailer among the numerous trailers that are in the vicinity (e.g. instruct the driver to travel in the direction that results in an increased RSSI or a decreased RTT until the matching trailer is located).

In either case, when trailer 555 is hooked to a tractor having the matching tractor owner ID, the driver-side software application compares the relative locations of trailer 555 with respect to tractor 101. This comparison is performed at hookup and after the start of hauling to ensure that trailer 555 is hooked to a tractor 101 having the matching tractor owner ID. If at any time, the comparison indicates that trailer 555 is not hooked to the tractor 101 having the matching tractor owner ID (e.g. relative locations are too far apart), the driver-side software application alerts the driver and outputs an alert message to the driver via the GUI and sends an alert message to the tractor owner via tractor-to-trailer verification server 205 indicating that a pickup error has occurred. The error could be a message such as “Tractor owner 444 has incorrectly picked up trailer 789! Please return trailer 789 and pickup matching trailer 555.”

As described above, trailer verification instructions displayed by the driver-side software application includes the trailer ID and tractor owner ID. The marching orders (e.g. pickup location, destination location, etc.) may optionally be displayed by the driver-side software application, or may be separately provided to the driver via the tractor owner's internal system.

A benefit to the disclosed solution is that the driver-side software application and the customer-side software application can be downloaded and installed as is typical with software applications in order to provide a solution that avoids driver pickup error and bridges a gap that currently exists between the customer's internal tractor/trailer monitoring software.

Although container 100 is shown in FIG. 1 as a trailer for a truck, it is noted that container 100 could be a container on any vehicle such as a train, a plane, a ship, or the like. Therefore, the tractor-to-trailer verification system described above could also be used in these examples (e.g. to match a container to its transportation means).

In addition, transportation is not the only application for this tractor-to-trailer verification system solution. In one example, the on-trailer solution could be an in-location solution installed in a room within a building. The smartphone user (student, worker, etc.) may receive instructions to go to a particular room in a building (e.g. school, office building, hospital, etc.). Upon entering the room, the in-location solution would transmit an ID (e.g. Bluetooth ID) to the smartphone. The user-side application would then compare the received Bluetooth ID to the room number received in the instructions. If a match is determined, then a match confirmation may be displayed to the smartphone user via the verification software application and sent to the customer (e.g. school administrator, company management, hospital management, etc.) and displayed on a customer-side application. If a mismatch is determined, then a mismatch alert may be displayed to the smartphone user via the application and sent to the customer via the customer-side application. Needless to say, the trailer ID system could also be implemented for any two or more items (e.g. objects, persons, etc.) that should be matched together in the same location.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

In the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in fewer than all features of a single disclosed embodiment. Thus the following claims are hereby incorporated into the Detailed Description, with each claim standing on its own as a separately claimed subject matter.

What is claimed is:

1. A tractor-to-trailer verification system comprising:
a tractor driver smart device; and
a trailer device in the trailer, the trailer device including:
a trailer transceiver, and
a trailer controller,
wherein the tractor-to-trailer verification system is configured to:
execute, on the tractor driver smart device, a driver-side software application displaying trailer verification instructions to the tractor driver, the trailer verification instructions received by the driver-side software application from a customer device, the trailer verification instructions including a trailer ID of the trailer and a tractor owner ID of the tractor, transmit, from the trailer transceiver to the tractor driver smart device, the trailer ID of the trailer, and
confirm, via the driver-side software application, a match between the trailer ID and the tractor owner ID.

2. The tractor-to-trailer verification system of claim 1,
wherein the tractor-to-trailer verification system is further configured to:
detect motion of the trailer, and
transmit, from the trailer transceiver to the tractor driver smart device, the trailer ID within a predetermined period of time from detecting motion of the trailer, and confirm during the motion, via the driver-side software application, a match between the trailer ID and the tractor owner ID of the tractor.

3. The tractor-to-trailer verification system of claim 2,
wherein the tractor-to-trailer verification system is further configured to repeatedly at predetermined intervals of time during the motion of the trailer, transmit, from the trailer transceiver to the tractor driver smart device, the trailer ID, and repeatedly confirm during the motion, via the driver-side software application, a match between the trailer ID and the tractor owner ID of the tractor.

4. The tractor-to-trailer verification system of claim 1,
wherein the tractor-to-trailer verification system is further configured to determine the match between the trailer ID and the tractor owner ID of the tractor by determining that a location of the trailer device and a location of the driver smart device are within predetermined range of one another.

5. The tractor-to-trailer verification system of claim 1,
wherein the tractor-to-trailer verification system is further configured to alert at least one of the tractor driver via the tractor driver smart device, or the customer via a customer-side software application executing on the customer device, when the trailer ID does not match the tractor owner ID.

6. The tractor-to-trailer verification system of claim 1,
wherein the customer device stores a database of trailers owned by the customer matched with the tractor owner.

7. The tractor-to-trailer verification system of claim 1,
wherein the driver-side software application displays a map for guiding the tractor driver to the trailer by comparing and displaying a location of the tractor driver smart device to a location of the trailer device.

8. The tractor-to-trailer verification system of claim 6,
wherein the driver-side software application executes on the driver smart device and the customer-side software application executes on the customer device such that:
the customer device uses the customer-side software application to match the trailer ID to the tractor owner ID prior to time of pickup, and
the driver smart device uses the driver-side software application to verify the match between the trailer ID to the tractor owner ID at the time of pickup.

9. The tractor-to-trailer verification system of claim 6,
wherein the customer-side software application executing on the customer device displays matching status of the trailers and tractor owner and displays an alert when a mismatch between the trailers and tractor owner is detected.

10. A hauler-to-asset verification system comprising:
a hauler smart device; and
an asset device attached to an asset, the asset device including:
an asset transceiver, and
an asset controller,
wherein the hauler-to-asset verification system is configured to:
execute, on the hauler smart device, a software application displaying asset verification instructions to the hauler, the asset verification instructions received by the software application from a customer device, the asset verification instructions including an asset ID of the asset and a hauler smart device ID of the hauler smart device,
transmit, from the asset transceiver to the hauler smart device, the asset ID of the asset, and
confirm, via the software application, a match between the asset ID and the hauler smart device ID.
